(19) United States
(12) Patent Application Publication
(10) Pub. No.: US 2026/0084525 A1
(43) Pub. Date: Mar. 26, 2026

(54) INFORMATION DISPLAY APPARATUS FOR VEHICLE

(71) Applicant: TOYOTA JIDOSHA KABUSHIKI KAISHA, Toyota-shi (JP)

(72) Inventor: Toru UENO, Niwa-gun (JP)

(73) Assignee: TOYOTA JIDOSHA KABUSHIKI KAISHA, Toyota-shi (JP)

(21) Appl. No.: 19/325,892

(22) Filed: Sep. 11, 2025

(30) Foreign Application Priority Data
Sep. 24, 2024 (JP) 2024-165275

(51) Int. Cl. B60K 35/22; B60K 35/10; B60K 35/28; B60K 35/29

(52) U.S. Cl. CPC B60K 35/22; B60K 35/10; B60K 35/28; B60K 35/29; B60K 2360/119; B60K 2360/1434; B60K 2360/1468; B60K 2360/165; B60K 2360/176; B60K 2360/1876

(57) ABSTRACT

An information display apparatus for a vehicle that records information of a video of an on-vehicle camera that images an outside of the vehicle and displays the video on a display unit of the vehicle. The information display apparatus includes a display control unit configured to display, on the display unit, a thumbnail image to select the video displayed on the display unit among the information of the recorded video; and an estimation unit configured to estimate occurrence of a predetermined incident in the vehicle based on a detection result of an external sensor or an internal sensor mounted on the vehicle. The display control unit is configured to, when the occurrence of the incident is estimated, add marker information to the thumbnail image corresponding to the video including information imaged at an estimated occurrence time of the incident, and cause the display unit to display the thumbnail image.

### CROSS-REFERENCE TO RELATED APPLICATION

This application is based upon and claims the benefit of priority from Japanese Patent Application No. 2024-165275, filed on Sep. 24, 2024, the entire contents of which are incorporated herein by reference.

### TECHNICAL FIELD

The present disclosure relates to an information display apparatus for a vehicle.

### BACKGROUND

Conventionally, there has been known a technique for playing back a moving image at or subsequent to a frame or a latest scene switching point when any frame is selected on a thumbnail display screen on which a first thumbnail array to be shifted left and right by an input device and a second thumbnail array to be shifted in conjunction with the shift of the first thumbnail array are displayed (e.g., Japanese Unexamined Patent Publication No. 2010-092246).

In an information display apparatus for a vehicle that records information of a video of an on-vehicle camera that images an outside of the vehicle and displays the video on a display unit of the vehicle, the display unit of the vehicle displays a thumbnail image to select and play back a video to be displayed on the display unit among information of the recorded video. Thumbnail images may be generated every predetermined time in the recorded video, and a plurality of thumbnail images may be displayed on the display unit. When such a plurality of thumbnail images are displayed on the display unit, it may be difficult for an occupant of the vehicle to specify a portion in which an incident having occurred to the vehicle has been imaged in the information of the recorded video only by seeing the plurality of thumbnail images.

### SUMMARY

An example of an information display apparatus for a vehicle is an information display apparatus for a vehicle that records information of a video of an on-vehicle camera that images an outside of the vehicle and displays the video on a display unit of the vehicle, and includes: a display control unit configured to display, on the display unit of the vehicle, a thumbnail image to select the video to be displayed on the display unit among the information of the recorded video; and an estimation unit configured to estimate occurrence of a predetermined incident in the vehicle based on a detection result of an external sensor or an internal sensor mounted on the vehicle, and the display control unit is configured to, when the occurrence of the incident is estimated, add marker information to the thumbnail image corresponding to the video including information imaged at an estimated occurrence time of the incident, and cause the display unit to display the thumbnail image.

In an example of the information display apparatus of the vehicle, the occurrence of the predetermined incident in the vehicle is estimated by the estimation unit based on the detection result of the external sensor or the internal sensor mounted on the vehicle. The display control unit is configured to, when the occurrence of the incident is estimated, add the marker information to the thumbnail image corresponding to the video including the information imaged at the estimated occurrence time of the incident, and the thumbnail image is displayed on the display unit. An occupant of the vehicle can easily visually distinguish the thumbnail image to which the marker information has been added from the thumbnail image to which the marker information is not added. Consequently, the occupant of the vehicle can easily specify a portion in which the incident having occurred to the vehicle has been imaged in the information of the recorded image.

In some examples, the internal sensor may include a sound sensor configured to acquire an in-vehicle sound of the vehicle, and the estimation unit may be configured to estimate the occurrence of the incident when a time change rate of at least one of an amplitude, a frequency, and a sound pressure of the in-vehicle sound is equal to or greater than a predetermined change rate threshold.

Another example of an information display apparatus for a vehicle is an information display apparatus for a vehicle that records information of a video of an on-vehicle camera that images an outside of the vehicle and displays the video on a display unit of the vehicle, and includes: a display control unit configured to display, on the display unit of the vehicle, a thumbnail image to select the video to be displayed on the display unit among the information of the recorded video; and an estimation unit configured to estimate occurrence of a predetermined incident in the vehicle based on a detection result of a sound sensor configured to acquire an in-vehicle sound of the vehicle when a time change rate of at least one of an amplitude, a frequency, and a sound pressure of the in-vehicle sound is equal to or greater than a predetermined change rate threshold, and the display control unit is configured to, when the occurrence of the incident is estimated, add marker information related to an estimated occurrence time to the thumbnail image corresponding to a video including information imaged at the estimated occurrence time of the incident, and cause the display unit to display the thumbnail image.

In another example of the information display apparatus of the vehicle, the occurrence of the predetermined incident in the vehicle is estimated by the estimation unit based on the in-vehicle sound acquired by the sound sensor. The display control unit is configured to, when the occurrence of the incident is estimated, add the marker information related to the estimated occurrence time to the thumbnail image corresponding to the video including the information imaged at the estimated occurrence time of the incident, and the thumbnail image is displayed on the display unit. The occupant of the vehicle can easily visually distinguish the thumbnail image to which the marker information related to the estimated occurrence time has been added from the thumbnail image to which the marker information is not added. Consequently, the occupant of the vehicle can easily specify a portion in which the incident having occurred to the vehicle has been imaged in the information of the recorded image.

In some examples, the display control unit may be configured to, when a selection operation of selecting the thumbnail image to which the marker information has been added is performed by the occupant of the vehicle, display the video on the display unit so as to start playback from the estimated occurrence time of the incident.

In some examples, the display control unit may be configured to, when occurrence of a plurality of the incidents is estimated and playback of the video is started from the estimated occurrence time of the incident, skip to a next estimated occurrence time among the plurality of estimated occurrence times and play back the video in response to that a predetermined forward operation is performed by an occupant of the vehicle, and skip to a previous estimated occurrence time among the plurality of estimated occurrence times and play back the video in response to that a predetermined reverse operation is performed by the occupant of the vehicle.

According to some examples of the present disclosure, it is easy to specify a portion in which an incident having occurred to a vehicle has been imaged in information of a recorded video.

### BRIEF DESCRIPTION OF THE DRAWINGS

FIG. 1 is a block diagram illustrating an example of an information display apparatus for a vehicle;

FIG. 2 is a view illustrating an example of a display unit of a vehicle and a thumbnail image;

FIG. 3A is a view illustrating an example of a recorded video;

FIG. 3B is a view illustrating an example of in-vehicle sound data corresponding to a recorded video;

FIG. 3C is a view illustrating an example of an estimated occurrence time of the incident estimated based on an in-vehicle sound;

FIG. 4 is a view illustrating an example of a thumbnail image to which marker information has been added;

FIG. 5 is a view illustrating an example of skip playback of a video;

FIG. 6 is a flowchart illustrating an example of processing of an ECU in FIG. 1;

FIG. 7 is a flowchart illustrating an example of estimation processing in FIG. 6;

FIG. 8A is a view illustrating an example of a recorded video;

FIG. 8B is a view illustrating an example of impact data corresponding to a recorded image;

FIG. 8C is a view illustrating an example of the estimated occurrence time of the incident estimated based on the impact data; and

FIG. 9 is a flowchart illustrating another example of the estimation processing in FIG. 6.

### DETAILED DESCRIPTION

Hereinafter, an example of the present disclosure will be described with reference to the drawings.

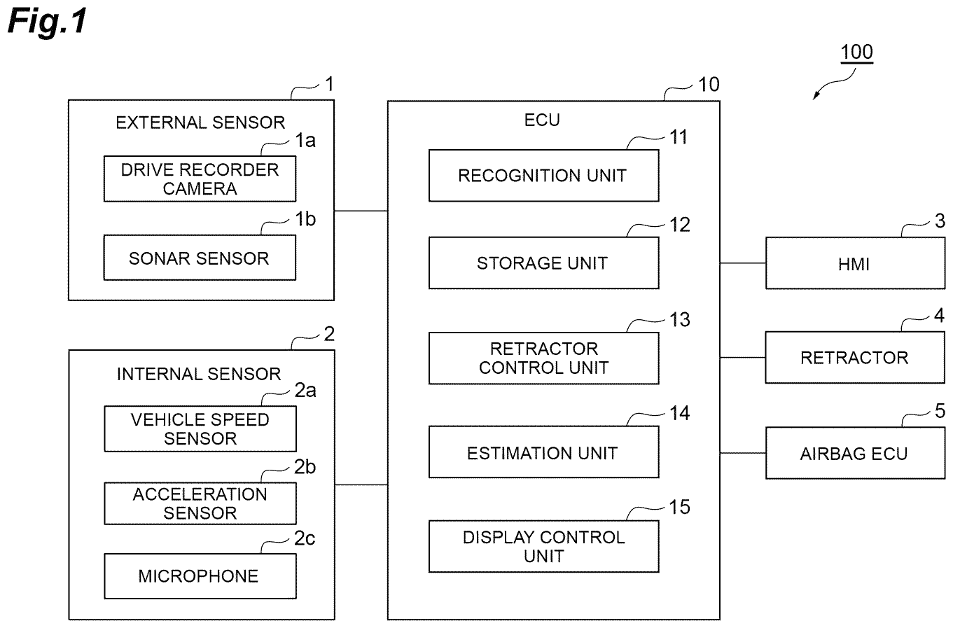

FIG. 1 is a block diagram illustrating an example of an information display apparatus for a vehicle. As shown in FIG. 1, an information display apparatus 100 of a vehicle is mounted on the vehicle such as a passenger car. The information display apparatus 100 of the vehicle is an apparatus for recording information of a video of a drive recorder camera 1a (on-vehicle camera) that images the outside of the vehicle, and displaying this video on a display 20 (display unit) of the vehicle. Note that part of functions of the information display apparatus 100 of the vehicle may be executed on a server that can communicate with the vehicle in one aspect.

### [Configuration of Information Display Apparatus for Vehicle]

Hereinafter, a configuration of an example of the information display apparatus 100 of the vehicle will be described with reference to FIG. 1. As shown in FIG. 1, the information display apparatus 100 of the vehicle includes an Electronic Control Unit [ECU] 10.

The ECU 10 is an electronic control unit that includes a Central Processing Unit [CPU] and a storage unit. The storage unit includes, for example, a Read Only Memory [ROM], a Random Access Memory [RAM], and an Electrically Erasable Programmable Read-Only Memory [EEPROM]. In the ECU 10, for example, various functions are implemented by the CPU by executing a program stored in the storage unit. The ECU 10 may include a plurality of electronic units.

The ECU 10 is connected with an external sensor 1, an internal sensor 2, a Human Machine Interface (HMI) 3, a retractor 4, and an airbag ECU 5.

The external sensor 1 includes, for example, the drive recorder camera 1a that images the outside of the vehicle, and a sonar sensor 1b.

The drive recorder camera 1a is a camera for imaging the outside of the vehicle. The drive recorder camera 1a is provided on, for example, an inner side of a windshield of the vehicle, and captures a video in front of the vehicle. The drive recorder camera 1a is used to intermittently or continuously record a video captured while the vehicle is stopping or traveling, and to record a situation at a time when an accident or a trouble occurs just in case. The drive recorder camera 1a may capture a video at the back of the vehicle. The drive recorder camera 1a may capture a video at the side of the vehicle. The drive recorder camera 1a may continuously capture a video in the surroundings of the vehicle by turning about the axis along the vertical direction of the vehicle. The drive recorder camera 1a transmits information of the captured video to the ECU 10.

The sonar sensor 1b is an ultrasonic sensor for detecting approach of the vehicle to an obstacle in the surroundings of the vehicle. The sonar sensor 1b is provided at, for example, a bumper of a vehicle. The sonar sensor 1b detects an obstacle by emitting an ultrasonic wave and receiving a reflected wave of the ultrasonic wave. The sonar sensor 1b transmits detected obstacle information to the ECU 10. Note that the sonar sensor 1b may be omitted.

The internal sensor 2 includes, for example, a vehicle speed sensor 2a, an acceleration sensor 2b, and a microphone 2c (sound sensor).

The vehicle speed sensor 2a is a detector that detects a speed of the vehicle. The vehicle speed sensor 2a transmits detected vehicle speed information to the ECU 10.

The acceleration sensor 2b is a detector that detects acceleration of the vehicle. The acceleration sensor 2b may detect the acceleration in a longitudinal direction and the acceleration in a lateral direction of the vehicle. The acceleration sensor 2b acquires acceleration information as impact data when an impact is applied to the vehicle from the outside. The acceleration sensor 2b transmits the detected acceleration information to the ECU 10.

The microphone 2c is a sound sensor configured to acquire in-vehicle sounds of the vehicle. The microphone 2c is provided at, for example, a ceiling or a dashboard inside the vehicle. The microphone 2c acquires a voice of an occupant and an in-vehicle sound heard in the vehicle. The in-vehicle sound is not limited to sounds produced in the vehicle, and may include sounds produced outside the vehicle and heard in the vehicle. The microphone 2c transmits the recorded data of the acquired in-vehicle sound to the ECU 10.

The HMI 3 is an interface for inputting and outputting information between the ECU 10 and the occupant. The HMI 3 includes, for example, the display 20, and a speaker provided in the vehicle interior. The HMI 3 outputs an image of the display and outputs a voice from the speaker according to a control signal from the ECU 10. The display 20 may function as a touch panel.

The display 20 may be a center display, may be a display for navigation, or may be a Head Up Display [HUD]. The HUD presents information to an occupant by projecting an image on the windshield of the vehicle.

The HMI 3 accepts an occupant's selection operation of selecting a thumbnail image. The selection operation of selecting the thumbnail image is, for example, an operation of touching the thumbnail image displayed on the touch panel.

The retractor 4 is a device for winding a seat belt of the vehicle. The retractor 4 normally winds the seat belt with a predetermined force such that the seat belt is appropriately tensioned. The retractor 4 may be controlled to operate a mechanism that locks feeding of the seat belt according to a signal from a retractor control unit 13. Note that the retractor 4 may be omitted.

The airbag ECU 5 controls an operation of an airbag based on the acceleration information detected by the acceleration sensor 2b. The airbag ECU 5 is an electronic control unit for controlling the airbag of the vehicle. The airbag ECU 5 controls an operation of an airbag based on the acceleration information detected by the acceleration sensor 2b. The airbag ECU 5 may transmit a signal for deploying the airbag to the ECU 10. Note that the airbag ECU 5 may be omitted.

Next, a functional configuration of the ECU 10 will be described. The ECU 10 includes a recognition unit 11, a storage unit 12, the retractor control unit 13, an estimation unit 14, and a display control unit 15.

The recognition unit 11 recognizes the video captured by the drive recorder camera 1a. The recognition unit 11 recognizes, based on the information of the video transmitted from the drive recorder camera 1a, a recorded video to be displayed on the display 20 and information such as the imaging time of the recorded video.

The recognition unit 11 generates a thumbnail image based on the recognized recorded video and imaging time and the like. The thumbnail image is an image for selecting and playing back a video to be displayed on the display 20. The recognition unit 11 may generate one thumbnail image every predetermined time of the recorded video. The recognition unit 11 may associate one thumbnail image with a playback start time of the recorded video corresponding to the thumbnail image. The recognition unit 11 may generate a plurality of thumbnail images for the recorded video captured during a past period up to the present.

The recognition unit 11 may recognize approach of the vehicle to an obstacle in the surroundings of the vehicle based on the obstacle information of the sonar sensor 1b. The recognition unit 11 may recognize the vehicle speed based on the vehicle speed information of the vehicle speed sensor 2a. The recognition unit 11 may recognize the acceleration of the vehicle based on the acceleration information of the acceleration sensor 2b.

The recognition unit 11 may recognize (acquire) the in-vehicle sound of the vehicle based on the recorded data of the in-vehicle sound of the microphone 2c. The recognition unit 11 may extract an envelope indicating change in amplitude of the in-vehicle sound of the vehicle from recorded data of the in-vehicle sound of the microphone 2c as recorded data for voice analysis to be described later.

The storage unit 12 stores information of the video recognized by the recognition unit 11 and the information related to the thumbnail images generated by the recognition unit 11. The storage unit 12 stores the recorded video as, for example, time-series image data, and stores the recorded audio data in association with the image data in time series. In the storage unit 12, a playback start time of the recorded video corresponding to each thumbnail image may be associated with the thumbnail image and stored. Note that the in-vehicle sound may be acquired and stored by the estimation unit 14 described later.

The retractor control unit 13 controls the retractor 4 so as to activate an Emergency Locking Retractor [ELR] function based on the acceleration information detected by the acceleration sensor 2b. When, for example, the detected acceleration exceeds a predetermined acceleration threshold, the retractor control unit 13 locks extension of the seat belt from the retractor 4. The acceleration threshold is a threshold of an acceleration corresponding to that at a time of sudden braking or collision. Note that the retractor 4 may be omitted.

The estimation unit 14 estimates occurrence of a predetermined incident to the vehicle based on a detection result of the external sensor 1 or the internal sensor 2 mounted on the vehicle. The predetermined incident means an event inside the vehicle or outside the vehicle that needs to be checked by playing back a recorded video captured during the past period up to the present. The predetermined incident described here includes, for example, an abnormality appearing in recorded data such as collision between another vehicle or an obstacle, and the vehicle, or production of a loud sound such as a loud voice of the occupant or a collision sound.

The display control unit 15 displays on the display 20 a thumbnail image 21 for selecting the video to be displayed on the display 20 among the information of the recorded video.

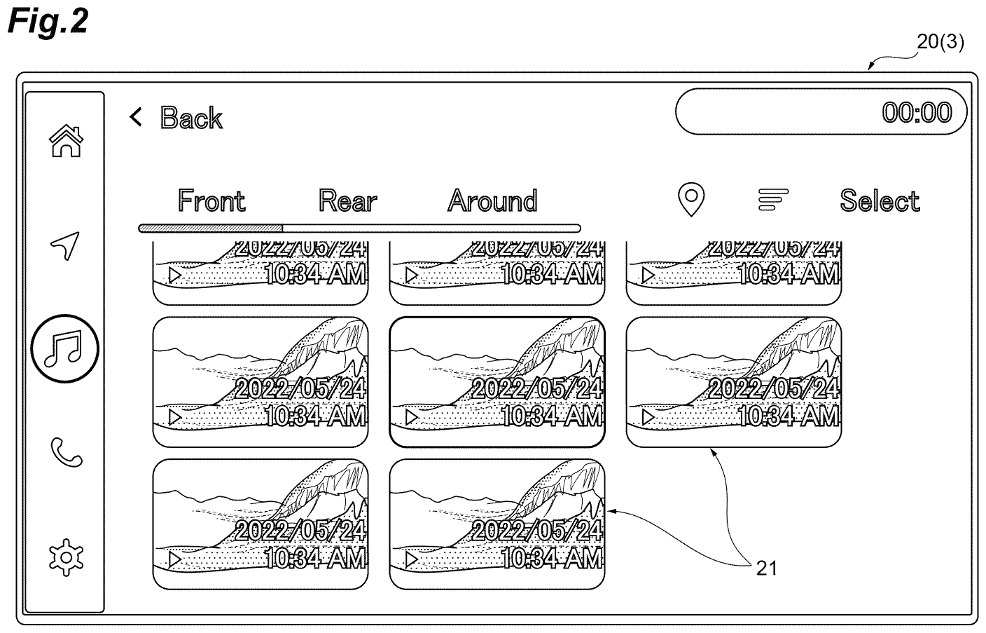

FIG. 2 is a view illustrating an example of the display unit of the vehicle and a thumbnail image. As shown in FIG. 2, the display 20 is, for example, a center display with a touch panel disposed on a dashboard of the vehicle. A plurality of the thumbnail images 21 are displayed on the display 20. The thumbnail image 21 is a representative still image extracted every predetermined time from the video captured by the drive recorder camera 1a.

A clock display indicating the current time is displayed at the upper part of the display 20, and “00:00” is displayed on the upper right. This clock display indicates a playback time of a video, and displays an elapsed time of the video that is being played back. For example, the plurality of thumbnail images 21 are displayed in a grid-like layout at the center of the display 20. In each thumbnail image 21, an imaging date and time are displayed in, for example, a format such as “2022/05/24 10:34 AM”. Tabs such as “Front”, “Rear”, and “Around” are displayed at the upper part of the thumbnail image 21. Videos of the front, the rear, and the surroundings of the vehicle may be switched by performing a touch operation on these tabs.

Estimation of occurrence of an incident will be described in more detail. Based on, for example, the recorded data acquired by the microphone 2c, the estimation unit 14 estimates the occurrence of the incident when a time change rate (the time change rate of the recorded data) of at least one of the amplitude, the frequency, and the sound pressure of the in-vehicle sound is equal to or greater than a predetermined change rate threshold. The change rate threshold is a threshold of the time change rate of the recorded data for determining whether or not to estimate that an incident has occurred.

Here, the estimation unit 14 calculates, for example, a time change rate of the sound pressure. The estimation unit 14 may calculate the time change rate of the sound pressure by, for example, calculating and differentiating a difference between adjacent samples in time series using the following difference equation for data obtained by applying a predetermined noise filter to the sound pressure as one item of recorded data.

$${x}^{′} ( t ) = \{ x ( t + Δ t ) / x ( t ) \} \times Δ t$$

Here, t represents a time, Δt represents a sample time of recorded data, x(t) represents the recorded data after filtering at a time t, and x′(t) represents a time change rate of the recorded data at the time t.

The estimation unit 14 may estimate that the incident has occurred at the time t at which the time change rate of the above recorded data has become equal to or greater than the predetermined change rate threshold, and estimate the time t as the estimated occurrence time of the incident. The estimated occurrence time of the incident is a time estimated as a time at which the incident has occurred. The estimated occurrence time of the incident includes a time that corresponds to the time of the clock, and a relative elapsed time from the playback start time of the recorded video associated with the thumbnail image including the time.

Note that the estimation unit 14 may estimate occurrence of the incident when a value of the envelope of the recorded data 23 is equal to or greater than a predetermined amplitude threshold. The estimation unit 14 may estimate the time t as the estimated occurrence time of the incident at the time t when the value of the envelope of the recorded data 23 becomes equal to or greater than the predetermined amplitude threshold.

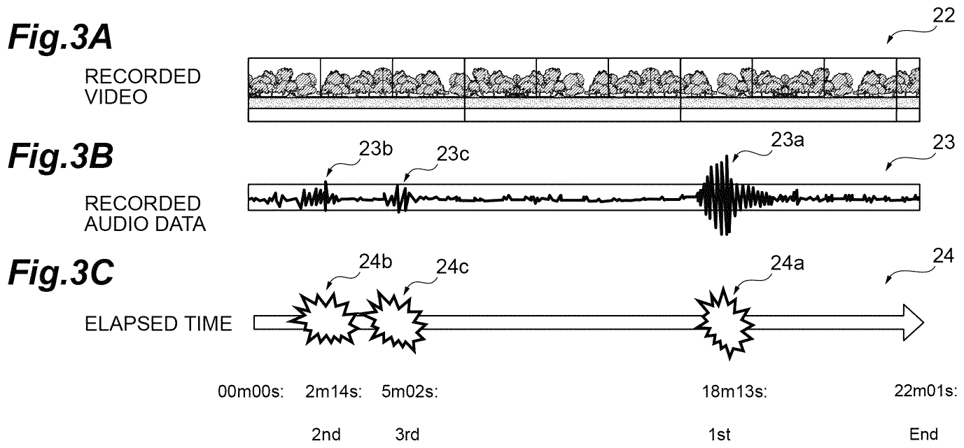

FIG. 3A is a view illustrating an example of a recorded video. FIG. 3B is a view illustrating an example of in-vehicle sound data corresponding to a recorded video. FIG. 3C is a view illustrating an example of an estimated occurrence time of the incident estimated based on an in-vehicle sound.

FIG. 3A shows a recorded video 22 that is a video captured by the drive recorder camera 1a. As for the recorded video 22, still images are continuously recorded along a time axis, and FIG. 3A shows a video in a specific time period.

FIG. 3B shows recorded data 23 of the in-vehicle sound. The recorded data 23 is acquired by the microphone 2c, and is associated so as to match with the time of the recorded video 22 along the time axis. The recorded data 23 indicates instantaneous change in sound pressure along the time axis. The envelope of the recorded data 23 may be a curve that connects peak values of the recorded data 23.

FIG. 3B shows sound pressure maximal parts 23a, 23b, and 23c. The sound pressure maximal parts 23a, 23b, and 23c correspond to portions at which the time change rate of the recorded data 23 is equal to or greater than the predetermined change rate threshold. The sound pressure maximal parts 23a, 23b, and 23c mean portions at which the sound pressure of the recorded data 23 is larger than that of the recorded data 23 at a normal time, and the sound pressure can take a maximal value. In the example in FIG. 3B, the sound pressure maximal part 23a indicates a peak of a maximum sound pressure, the sound pressure maximal part 23b indicates a peak of a second largest sound pressure, and the sound pressure maximal part 23c indicates a peak of a third largest sound pressure. Occurrence of an incident is estimated by the estimation unit 14 at the sound pressure maximal parts 23a, 23b, and 23c.

FIG. 3C shows an elapsed time 24. The elapsed time 24 is a relative elapsed time using as an origin a start time of a specific time period of the recorded video 22 (00 m00 s). The elapsed time 24 may be, for example, a relative elapsed time using as the origin the playback start time of the recorded video 22 at a time of selection of the thumbnail image corresponding to the recorded video 22. An end point (22 m01 s) of the elapsed time 24 may be an end time of the recorded video 22.

FIG. 3C shows estimated occurrence times 24a, 24b, and 24c of the incident. The estimated occurrence times 24a, 24b, and 24c are associated with the sound pressure maximal parts 23a, 23b, and 23c, respectively. The estimated occurrence times 24a, 24b, and 24c mean times at which the occurrence of the incident has been estimated at each of the sound pressure maximal parts 23a, 23b, and 23c. The estimated occurrence time 24a indicates the estimated occurrence time of the incident at which the occurrence has been estimated at the sound pressure maximal part 23a (18 m13 s). The estimated occurrence time 24b indicates the estimated occurrence time of the incident at which the occurrence has been estimated at the sound pressure maximal part 23b (2 m14 s). The estimated occurrence time 24c indicates the estimated occurrence time of the incident at which the occurrence has been estimated at the sound pressure maximal part 23c (5 m02 s).

When the occurrence of the incident is estimated, the display control unit 15 adds the marker information related to the estimated occurrence time to the thumbnail image 21 corresponding to the video including the information imaged at the estimated occurrence time of the incident, and causes the display 20 to display the thumbnail image with the marker information.

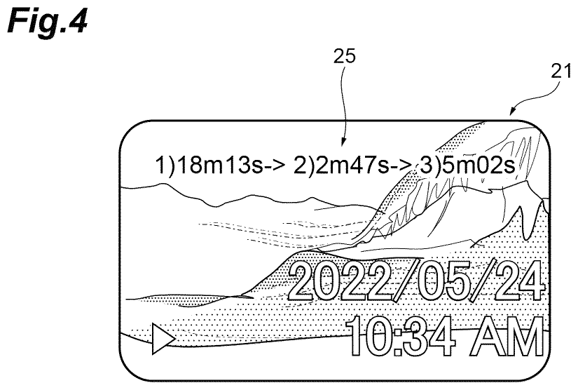

FIG. 4 is a view illustrating an example of a thumbnail image to which marker information has been added. FIG. 4 shows the thumbnail images 21 and marker information 25. The thumbnail image 21 is the thumbnail image 21 including a time at which the occurrence of the incident has been estimated among the plurality of thumbnail images 21 displayed on the display 20.

The marker information 25 is visual information related to the estimated occurrence time. The marker information 25 can be, for example, a character string indicating the estimated occurrence time of the incident. The marker information 25 may be superimposed and displayed on the thumbnail image 21. In FIG. 4, the marker information 25 is superimposed and displayed on the thumbnail image 21 in a format such as “1) 18 m13 s->2) 2 m47 s->3) 5 m02 s” at the upper part of the thumbnail image 21. Note that “->” means a rightward arrow.

The marker information 25 may include visual information related to incident scales of a plurality of incidents. In the example in FIG. 4, in the marker information 25, estimated occurrence times of the plurality of incidents are arranged in order of higher peaks of the sound pressures of the sound pressure maximal parts 23a, 23b, and 23c as an example of the incident scales.

When the selection operation of selecting the thumbnail image 21 to which the marker information 25 has been added is performed by the occupant of the vehicle, the display control unit 15 may display the video on the display 20 so as to start playback from the estimated occurrence time of the incident. When, for example, the occupant of the vehicle taps the thumbnail image 21 on the display 20 that displays the thumbnail image 21 to which the marker information 25 has been added, the display control unit 15 may recognize that the selection operation has been performed.

When recognizing that the selection operation has been performed, the display control unit 15 may read from the storage unit 12 the recorded video 22 corresponding to the thumbnail image 21 to which the marker information 25 has been added, and start playing back the recorded video 22 from the estimated occurrence time of the incident. In this case, when there are a plurality of estimated occurrence times of the incidents, the display control unit 15 may start playing back the recorded video 22 from the estimated occurrence time 24a of the incident whose scale is the largest.

When the occurrence of the plurality of incidents is estimated and playback of the recorded video 22 is started from the estimated occurrence time 24a of the incident, the display control unit 15 may skip to another estimated occurrence time 24b or estimated occurrence time 24c, and play back the recorded video 22.

The display control unit 15 may skip to the next estimated occurrence time among the plurality of estimated occurrence times and play back the video in response to a predetermined forward operation being performed by the occupant of the vehicle. The display control unit 15 may skip to the previous estimated occurrence time among the plurality of estimated occurrence times and play back the video in response to the predetermined reverse operation being performed by the occupant of the vehicle.

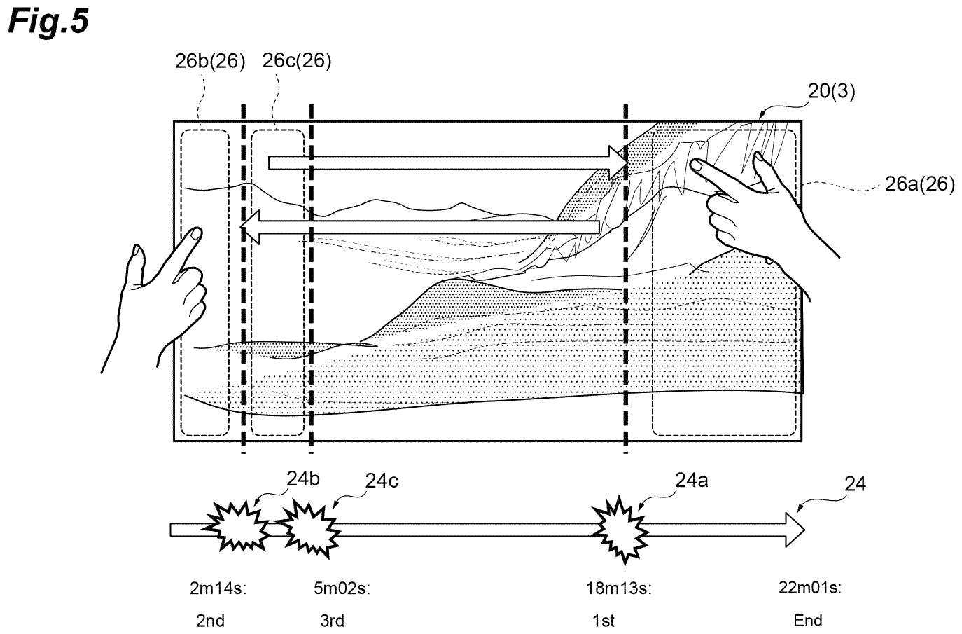

FIG. 5 is a view illustrating an example of skip playback of a video. In FIG. 5, a playback screen of the recorded video 22 is displayed on the display 20. The predetermined forward operation and reverse operation may be occupant's operations on a selection area 26 set in advance on the display 20.

The predetermined forward operation can be, for example, an occupant's operation of tapping a right selection area 26a in the display area of the display 20. The predetermined forward operation may be an occupant's operation of swiping from the left side of the selection area 26a toward the right side of the selection area 26a in the display area of the display 20.

The selection area 26a includes a right end part of the display 20, and may be an area from the right end part of the display 20 to a lateral position of the display 20 associated with the estimated occurrence time 24a closest to an end time if a time from the start to the end of the elapsed time 24 is associated with the entire lateral width of the display 20. The selection area 26a is not limited to this example, and may be an area having a predetermined lateral width including the right end part of the display 20.

In the example in FIG. 5, when the predetermined forward operation is performed if the estimated occurrence time 24b is the playback start time, playback can be performed from the estimated occurrence time 24c. When the predetermined forward operation is performed if the estimated occurrence time 24c is the playback start time, playback can be performed from the estimated occurrence time 24a.

The predetermined reverse operation can be, for example, an occupant's operation of tapping a left selection area 26b in the display area of the display 20. The predetermined reverse operation may be an occupant's operation of swiping from the right side of the selection area 26a toward the left side of the selection area 26b in the display area of the display 20.

The selection area 26b includes a left end part of the display 20, and may be an area from the left end part of the display 20 to the lateral position of the display 20 associated with the estimated occurrence time 24b closest to the start time when the time from the start to the end of the elapsed time 24 is associated with the entire lateral width of the display 20. The selection area 26b is not limited to this example, and may be an area having a predetermined lateral width including the left end part of the display 20.

In the example in FIG. 5, when the predetermined reverse operation is performed if the estimated occurrence time 24a is the playback start time, playback can be performed from the estimated occurrence time 24c. When the predetermined reverse operation is performed if the estimated occurrence time 24c is the playback start time, playback can be performed from the estimated occurrence time 24b.

A plurality of the selection areas 26 may be set to at least one of a right half and a left half of the display 20. For example, a selection area 26c is an area from the lateral position of the display 20 associated with the estimated occurrence time 24b closest to the start time, to the lateral position of the display 20 associated with the estimated occurrence time 24c that is the second closest to the start time, if the time from the start to the end of the elapsed time 24 is associated with the entire lateral width of the display 20.

The operation of tapping the selection area 26c is regarded as the predetermined forward operation if the estimated occurrence time 24b is the playback start time, and playback can be performed from the estimated occurrence time 24c. The operation of tapping the selection area 26c is regarded as a predetermined reverse operation if the estimated occurrence time 24a is the playback start time, and playback can be performed from the estimated occurrence time 24c.

### [Operation of Information Display Apparatus for Vehicle]

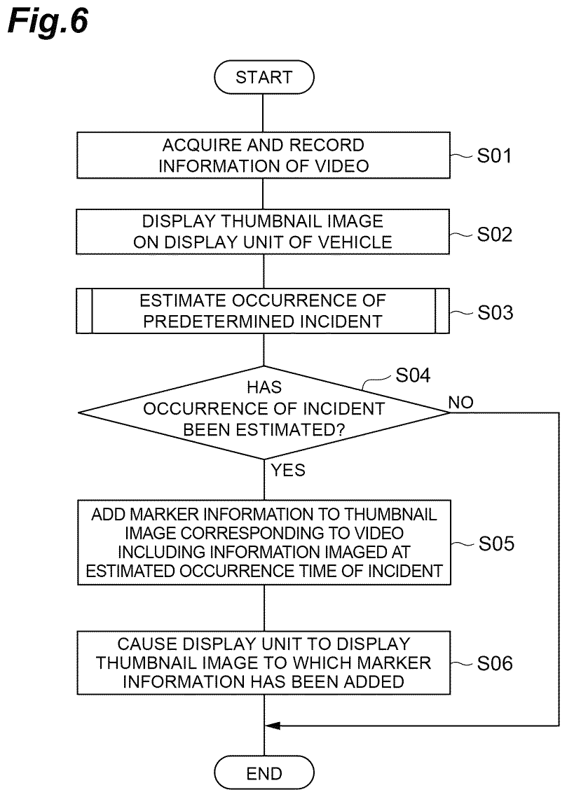

Next, an operation of the information display apparatus 100 of the vehicle will be described with reference to the drawings. FIG. 6 is a flowchart illustrating an example of processing of the ECU in FIG. 1. The processing in FIG. 6 is executed when, for example, the ECU 10 is powered on and when a recorded video is captured during a past predetermined period up to the present.

As shown in FIG. 6, in step S01, the ECU 10 of the information display apparatus 100 of the vehicle causes the recognition unit 11 to acquire and record information of a video. The recognition unit 11 acquires the information of the video transmitted from the drive recorder camera 1a, and recognizes a recorded video and an imaging time of the recorded video. The recognition unit 11 stores the recorded video as time-series image data in the storage unit 12. The recognition unit 11 associates the recorded data with the image data in time series to store in the storage unit 12.

In step S02, the ECU 10 causes the recognition unit 11 and the display control unit 15 to display the thumbnail image on the display unit of the vehicle. The recognition unit 11 generates a thumbnail image based on the recognized recorded video and imaging time. The display control unit 15 displays on the display 20 a thumbnail image 21 for selecting the video to be displayed on the display 20 among the information of the recorded video.

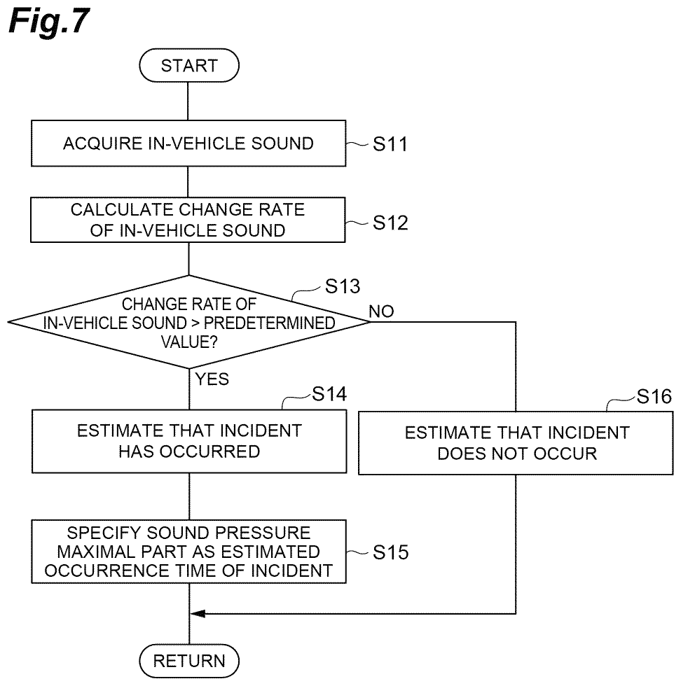

In step S03, the ECU 10 causes the recognition unit 11 and the estimation unit 14 to estimate occurrence of a predetermined incident. The recognition unit 11 and the estimation unit 14 estimate the occurrence of the incident based on the detection result of the external sensor 1 or the internal sensor 2 mounted on the vehicle by, for example, performing the processing in FIG. 7.

FIG. 7 is a flowchart illustrating an example of estimation processing in FIG. 6. The processing in FIG. 7 is executed every sample time of the recorded data if, for example, the recorded video is captured during a past predetermined period up to the present.

In step S11, the ECU 10 causes the recognition unit 11 to acquire in-vehicle sounds. The recognition unit 11 acquires the in-vehicle sound of the vehicle based on recorded data of the in-vehicle sound transmitted from the microphone 2c. Note that the in-vehicle sound may be acquired by the estimation unit 14.

In step S12, the ECU 10 causes the estimation unit 14 to calculate the change rate of the in-vehicle sound. The estimation unit 14 calculates a time change rate of at least one of the amplitude, the frequency, and the sound pressure of the in-vehicle sound based on, for example, the recorded data acquired by the microphone 2c. The estimation unit 14 may calculate the time change rate of the sound pressure of the in-vehicle sound using the above-described difference equation.

In step S13, the ECU 10 causes the estimation unit 14 to determine whether or not the change rate of the in-vehicle sound exceeds the predetermined change rate threshold. When determining that the change rate of the in-vehicle sound exceeds the predetermined change rate threshold (step S13: YES), the ECU 10 proceeds to step S14. When determining that the change rate of the in-vehicle sound is less than the predetermined change rate threshold (step S13: NO), the ECU 10 proceeds to step S16.

In step S14, the ECU 10 causes the estimation unit 14 to estimate that an incident has occurred. The estimation unit 14 estimates the occurrence of the incident in response to determination that the change rate of the in-vehicle sound exceeds the predetermined change rate threshold.

In step S15, the ECU 10 causes the estimation unit 14 to specify the sound pressure maximal part as the estimated occurrence time of the incident. The estimation unit 14 specifies a portion of the recorded data at a sample time of current processing as the sound pressure maximal part, and estimates the sample time of the current processing as the estimated occurrence time of the incident. Thereafter, the current processing in FIG. 7 is ended, and the processing returns to S04 in FIG. 6.

In step S16, the ECU 10 causes the estimation unit 14 to estimate that an incident does not occur. The estimation unit 14 does not estimate the occurrence of the incident in response to determination that the change rate of the in-vehicle sound is less than the predetermined change rate threshold. Thereafter, the current processing in FIG. 7 is ended, and the processing returns to S04 in FIG. 6.

Referring back to FIG. 6, in step S04, the ECU 10 causes the display control unit 15 to determine whether or not the occurrence of the incident has been estimated. When estimating the occurrence of the incident (step S04: YES), the ECU 10 proceeds to step S05. When not estimating the occurrence of the incident (step S04: NO), the ECU 10 ends the current processing in FIG. 6.

In step S05, the ECU 10 causes the display control unit 15 to add the marker information to the thumbnail image corresponding to the video including the information imaged at the estimated occurrence time of the incident. The display control unit 15 adds a character string indicating the estimated occurrence time of the incident as the marker information 25 to, for example, the thumbnail image 21 corresponding to the video including the information imaged at the estimated occurrence time of the incident.

In step S06, the ECU 10 causes the display control unit 15 to display on the display unit the thumbnail image to which the marker information has been added. The display control unit 15 displays on the display 20 the thumbnail image 21 to which the marker information 25 has been added. Thereafter, the current processing in FIG. 6 is ended.

In the above-described information display apparatus 100 of the vehicle, the estimation unit estimates occurrence of a predetermined incident in the vehicle based on the detection result of the external sensor or the internal sensor mounted on the vehicle. The display control unit is configured to, when the occurrence of the incident is estimated, add the marker information to the thumbnail image corresponding to the video including the information imaged at the estimated occurrence time of the incident, and the thumbnail image is displayed on the display unit. An occupant of the vehicle can easily visually distinguish the thumbnail image to which the marker information has been added from the thumbnail image to which the marker information is not added. Consequently, the occupant of the vehicle can easily specify a portion in which the incident having occurred to the vehicle has been imaged in the information of the recorded image.

In the information display apparatus 100, the internal sensor may include a sound sensor that acquires an in-vehicle sound of the vehicle, and the estimation unit may estimate the occurrence of the incident when a time change rate of at least one of an amplitude, a frequency, and a sound pressure of the in-vehicle sound is equal to or greater than a predetermined change rate threshold. In this case, the estimation unit can estimate the occurrence of the predetermined incident to the vehicle based on the in-vehicle sound acquired by the sound sensor.

In the information display apparatus 100, when the selection operation of selecting a thumbnail image to which marker information has been added is performed by the occupant of the vehicle, the display control unit may display a video on the display unit so as to start playback from the estimated occurrence time of the incident. In this case, the occupant of the vehicle can easily play back a video from the estimated occurrence time of the incident by visually recognizing the thumbnail image to which the marker information has been added and performing the selection operation on the thumbnail image.

In the information display apparatus 100, when occurrence of the plurality of incidents is estimated and playback of the video is started from the estimated occurrence time of the incident, the display control unit may skip to a next estimated occurrence time among the plurality of estimated occurrence times and play back the video in response to that a predetermined forward operation is performed by an occupant of the vehicle, and skip to a previous estimated occurrence time among the plurality of estimated occurrence times and play back the video in response to that a predetermined reverse operation is performed by the occupant of the vehicle. In this case, the occupant of the vehicle can easily play back the video from any estimated occurrence time of the plurality of incidents by performing the forward operation or the reverse operation.

Although an example of the present disclosure has been described above, the present disclosure is not limited to the example described above. The present disclosure can be implemented in various forms variously modified and improved based on knowledge of those skilled in the art in addition to the above-described example.

Although an abnormality appearing in recorded data has been exemplified as a predetermined incident in the above example, the present disclosure is not limited to this example. The predetermined incident may be an abnormality that appears in acceleration data or impact data. The abnormality appearing in the acceleration data or the impact data may include, for example, sudden acceleration, sudden braking, or sudden steering corresponding to an emergency avoidance situation. The abnormality appearing in the acceleration data or the impact data may include activation of the ELR of the seat belt or deployment of the airbag.

The estimation unit 14 may estimate the occurrence of the predetermined incident in the vehicle based on the acceleration information detected by the acceleration sensor 2b as the impact data. The estimation unit 14 may estimate the occurrence of the predetermined incident as the impact data when, for example, the retractor 4 is controlled by the retractor control unit 13 to cause the ELR function to work. The estimation unit 14 may estimate the occurrence of the predetermined incident according to, for example, a signal for deploying the airbag transmitted from the airbag ECU 5 to the ECU 10 as the impact data.

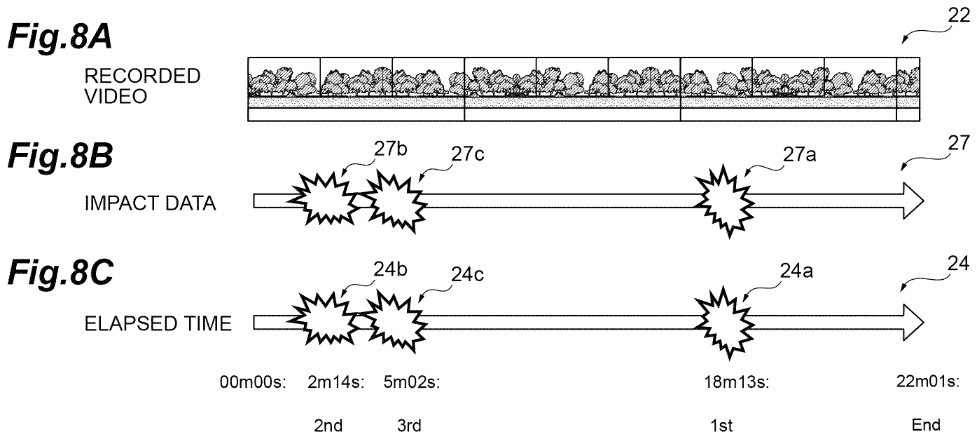

FIG. 8A is a view illustrating an example of a recorded video. FIG. 8B is a view illustrating an example of impact data corresponding to a recorded image. FIG. 8C is a view illustrating an example of the estimated occurrence time of the incident estimated based on the impact data.

As shown in FIG. 8B, the estimation unit 14 may estimate the occurrence of the predetermined incident in the vehicle based on impact data 27 instead of the recorded data 23 in FIG. 3B. Impact maximal parts 27a, 27b, and 27c are portions of the impact data 27 at which occurrence of the incident has been estimated by the estimation unit 14, and correspond to portions in which an impact becomes maximal. The estimated occurrence times 24a, 24b, and 24c are associated with the impact maximal parts 27a, 27b, and 27c, respectively.

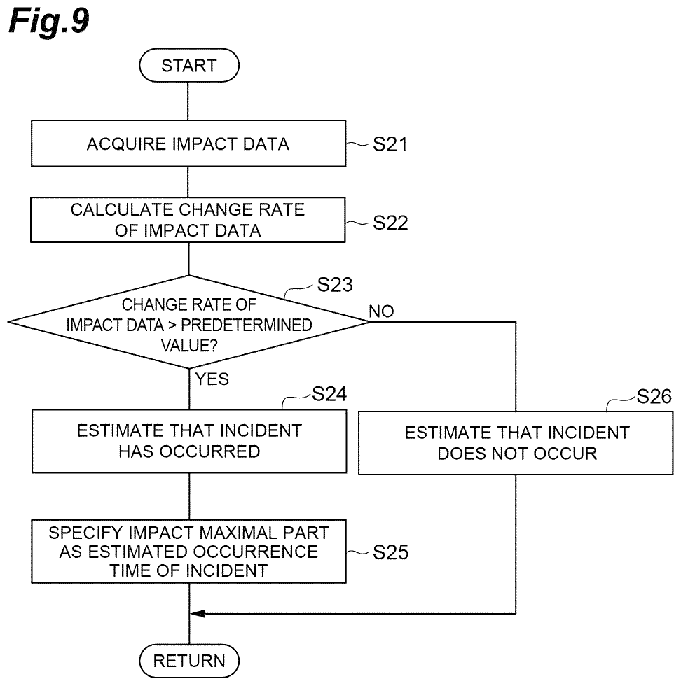

FIG. 9 is a flowchart illustrating another example (a modified example in FIG. 7) of estimation processing in FIG. 6. In the flowchart in FIG. 9, processing in steps S21 to S23 and S25 is different from the processing in steps S11 to S13 and S15.

In step S21, the ECU 10 causes the recognition unit 11 to acquire impact data. The recognition unit 11 acquires impact data based on the acceleration information detected by the acceleration sensor 2b. In step S22, the ECU 10 causes the estimation unit 14 to calculate a change rate of the impact data. The estimation unit 14 may calculate the change rate of the impact data using the above-described difference equation. As described above, the estimation unit 14 may calculate the change rate of the impact data that exceeds a predetermined value when the retractor 4 is controlled by the retractor control unit 13 to activate the ELR function, or when receiving a signal that is transmitted from the airbag ECU 5 to the ECU 10 and is used to deploy the airbag.

In step S23, when it is determined that the impact data exceeds the predetermined change rate threshold (step S23: YES), the ECU 10 performs processing similar to that in step S14 as step S24, and causes the estimation unit 14 to specify the impact maximal part as the estimated occurrence time of the incident in step S25. The estimation unit 14 specifies a portion of the impact data at the sample time of the current processing as the impact maximal part, and estimates the sample time of the current processing as the estimated occurrence time of the incident. Thereafter, the current processing in FIG. 9 is ended, and the processing returns to S04 in FIG. 6.

Alternatively, the predetermined incident may be an abnormality appearing in the obstacle information detected by the sonar sensor 1b. As the abnormality appearing in the obstacle information, while a situation that the obstacle information is detected by the sonar sensor 1b when the vehicle is traveling at low speed is not abnormal, a situation that the obstacle information is detected by the sonar sensor 1b when the vehicle is not traveling at low speed can be regarded as abnormal.

The estimation unit 14 may estimate occurrence of a predetermined incident as the abnormality appearing in the obstacle information when, for example, the vehicle speed is equal to or greater than a predetermined vehicle speed threshold and an obstacle is detected by the sonar sensor 1b. The predetermined vehicle speed threshold is a vehicle speed threshold associated with a state where the vehicle is not traveling at low speed to such an extent that there is a certain probability or more that the vehicle cannot stop without hitting an obstacle when the obstacle is detected by the sonar sensor 1b while the vehicle is driving at the vehicle speed.

Although the character string indicating the estimated occurrence time of the incident has been exemplified as the visual information related to the occurrence estimated time of the marker information 25 in the above example, the marker information 25 is not limited to the marker information related to the occurrence estimated time. The marker information may be a mark image such as a simple figure. Furthermore, although the marker information is superimposed and displayed at the upper part of the thumbnail image 21, the marker information may be displayed at a corner part of the thumbnail image 21, or may be displayed in a frame shape surrounding the surroundings of the thumbnail image 21.

Although the touch operation on the thumbnail image displayed on the touch panel has been exemplified as the selection operation of selecting the thumbnail image in the above example, the selection operation is not limited to this example. For example, the selection operation of selecting the thumbnail image may be an operation of pushing an operation button provided to a steering wheel of the vehicle.

Although, in the above example, when occurrence of the plurality of incidents is estimated and playback of the recorded video 22 is started from the estimated occurrence time of one incident, the display control unit 15 skips to another estimated occurrence time and plays back the recorded video 22, this example may be omitted.

Although the recognition unit 11 acquires the in-vehicle sound of the vehicle based on the recorded data of the in-vehicle sound transmitted from the microphone 2c in the above example, the recognition unit 11 may acquire the in-vehicle sound using the microphone in the drive recorder camera 1a if the microphone is provided to the drive recorder camera 1a. Furthermore, the sound sensor may be provided outside the vehicle.

What is claimed is:

1. An information display apparatus for a vehicle that records information of a video of an on-vehicle camera that images an outside of the vehicle and displays the video on a display unit of the vehicle, the information display apparatus comprising:
a display control unit configured to display, on the display unit of the vehicle, a thumbnail image to select the video to be displayed on the display unit among the information of the recorded video; and
an estimation unit configured to estimate occurrence of a predetermined incident in the vehicle based on a detection result of an external sensor or an internal sensor mounted on the vehicle,
wherein the display control unit is configured to, when the occurrence of the incident is estimated, add marker information to the thumbnail image corresponding to the video including information imaged at an estimated occurrence time of the incident, and cause the display unit to display the thumbnail image.

2. The information display apparatus of the vehicle according to claim 1, wherein
the internal sensor includes a sound sensor configured to acquire an in-vehicle sound of the vehicle, and
the estimation unit is configured to estimate the occurrence of the incident when a time change rate of at least one of an amplitude, a frequency, and a sound pressure of the in-vehicle sound is equal to or greater than a predetermined change rate threshold.

3. An information display apparatus for a vehicle that records information of a video of an on-vehicle camera that images an outside of the vehicle and displays the video on a display unit of the vehicle, the information display apparatus comprising:
a display control unit configured to display, on the display unit of the vehicle, a thumbnail image to select the video to be displayed on the display unit among the information of the recorded video; and
an estimation unit configured to estimate occurrence of a predetermined incident in the vehicle based on a detection result of a sound sensor configured to acquire an in-vehicle sound of the vehicle when a time change rate of at least one of an amplitude, a frequency, and a sound pressure of the in-vehicle sound is equal to or greater than a predetermined change rate threshold,
wherein the display control unit is configured to, when the occurrence of the incident is estimated, add marker information related to an estimated occurrence time to the thumbnail image corresponding to a video including information imaged at the estimated occurrence time of the incident, and cause the display unit to display the thumbnail image.

4. The information display apparatus of the vehicle according to claim 1, wherein the display control unit is configured to, when a selection operation of selecting the thumbnail image to which the marker information has been added is performed by an occupant of the vehicle, display the video on the display unit so as to start playback from the estimated occurrence time of the incident.

5. The information display apparatus of the vehicle according to claim 1, wherein the display control unit is configured to,
when occurrence of a plurality of the incidents is estimated and playback of the video is started from the estimated occurrence time of the incident,
skip to a next estimated occurrence time among the plurality of estimated occurrence times and play back the video in response to that a predetermined forward operation is performed by an occupant of the vehicle, and
skip to a previous estimated occurrence time among the plurality of estimated occurrence times and play back the video in response to that a predetermined reverse operation is performed by the occupant of the vehicle.

6. The information display apparatus of the vehicle according to claim 3, wherein the display control unit is configured to, when a selection operation of selecting the thumbnail image to which the marker information has been added is performed by an occupant of the vehicle, display the video on the display unit so as to start playback from the estimated occurrence time of the incident.

7. The information display apparatus of the vehicle according to claim 3, wherein the display control unit is configured to,
when occurrence of a plurality of the incidents is estimated and playback of the video is started from the estimated occurrence time of the incident,
skip to a next estimated occurrence time among the plurality of estimated occurrence times and play back the video in response to that a predetermined forward operation is performed by an occupant of the vehicle, and
skip to a previous estimated occurrence time among the plurality of estimated occurrence times and play back the video in response to that a predetermined reverse operation is performed by the occupant of the vehicle.
